(19) United States
(12) Patent Application Publication
(10) Pub. No.: US 2014/0195565 A1
(43) Pub. Date: Jul. 10, 2014

(54) SYSTEM AND METHOD FOR GENERATING AN ACCOUNT NUMBER AUTOMATICALLY

(71) Applicant: Infosys Limited, Bangalore (IN)

(72) Inventor: Kaniyanoor Seshadri Rajasekaran, Bangalore (IN)

(73) Assignee: Infosys Limited, Bangalore (IN)

(21) Appl. No.: 14/110,231

(22) PCT Filed: Dec. 26, 2011
(86) PCT No.: PCT/IN11/00891

§ 371 Date: Oct. 7, 2013

(30) Foreign Application Priority Data
Apr. 7, 2011 (IN) 1196/CHE/2011

(51) Int. Cl. G06F 17/30

(52) U.S. Cl. CPC G06F 17/30339
USPC 707/803

(57) ABSTRACT

A system and method for generating an account number are described. In an example embodiment, the creation of a first table and a first field, capable of receiving alphanumeric characters, is disclosed. An alphanumeric input is received and recorded in the first field, and a sequence number associated with the input so received is recorded. In a further aspect of the present invention, a second table is created, and an account number key stored therein. An account number may then be generated in accordance with the key. In an additional aspect, an alphanumeric field may be created specifically to aid in the application of a check digit methodology

### RELATED APPLICATION DATA

This application claims priority to International Patent Application No. PCT/IN2011/000891, filed Dec. 26, 2011, which claimed priority to 1196/CHE/2011, filed Apr. 7, 2011, the disclosures of both of which are hereby incorporated by reference in their entireties.

### BACKGROUND

The invention relates to the field of number assignment based identification methods, generally. In particular, the invention relates to the generation of a number automatically, where the number is used in the identification of a user, product or service. More specifically, the invention relates to the generation of an account number in banking applications.

Present methods of account number generation and assignment in the banking sector involve the maintenance of an account number database, and the creation of a suitable account number, as a need arises, by reading a sequence number from the database and incrementing the sequence number to obtain a new account number. This practice is inefficient in that it requires the retrieval of the entire sequence number every single time a new account number is to be generated. In addition, such a method, maintained over a long period, may result in large and unwieldy account numbers that are unintuitive and hard to remember for a customer.

A second practice in the field involves the use of a bank maintainable series. Such a series may include a prefix set and suffix set, the prefix and suffix set in predetermined formats. This allows for a simpler and more readable account number format. However, this too is limited, in that, by setting limitations on the format acceptable for the prefix and suffix, this method precludes the possibility of picking and choosing any, continuous, part of the elements involved in an account number format to generate a new account number. Additionally, the use of an integrity check, like check digit generation, for example, would be restricted to the entire account number, and could not intuitively be performed on a subset of elements therein.

What is required, then, is an automatic account number generation facility that may be tailored by a bank to fit each, or all, of the requirements listed above. Such a facility would provide the additional benefit of reducing the size of an account number to what is applicable in the banking application through which it is handled.

Accordingly, there is a need for a system and method for generating a bank account number automatically that takes into account the above factors, among others.

### SUMMARY

A system and method for generating an account number are provided.

In an aspect of a present implementation, a computer implemented method for the generation of an account number is described. As disclosed, the method may comprise the creation of a first table and the definition of a first field in the first table, wherein the first field is adapted to receive at least one alphanumeric character. The method may additionally disclose the reception of an alphanumeric string in the first field, wherein the alphanumeric string comprises one or more alphanumeric characters, the generation of a sequence number; and the storage of the sequence number in the first table.

In a further aspect, a system for generating an account number automatically is described. The system includes a processor readable storage medium in operable communication with a processor. The processor readable storage medium contains one or more programming instructions, the one or more programming instructions for creating a first table, the first table stored in the processor readable storage medium, defining a first field in the first table wherein the first field is adapted to receive at least one alphanumeric character, receiving an alphanumeric string in the first field, wherein the alphanumeric string comprises one or more alphanumeric characters, generating a sequence number, and storing the sequence number in the first table.

Further features, including the structure and operation of various embodiments, are described in the detailed description below. Such embodiments are to be understood in light of said detailed description in conjunction with the accompanying drawings to which it may refer.

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 is an illustration of a computer implemented method for the generation of an account number, in accordance with an embodiment of the invention.

FIG. 2 is an illustration of a computer implemented method for the generation of an account number using an account number key received, in accordance with an embodiment of the invention.

FIG. 3 is a depiction of a computing environment involved in the generation of an account number, in accordance with an embodiment of the invention.

FIG. 4 is an illustration of an aspect of a system for generating an account number, in accordance with an embodiment of the invention.

FIG. 5 is an example embodiment of a system for generating an account number, wherein the maintenance of multiple account numbers internally is depicted, in accordance with an embodiment of the invention.

FIG. 6 is an example embodiment of a system for generating an account number, wherein a set of elements that may comprise the account number are depicted, in accordance with an embodiment of the invention.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

In the following description, the term ‘account number’, when used specifically in the context of a bank related account number, serves as a particular example of an intended usage, and is not intended to limit the applicability of the described invention.

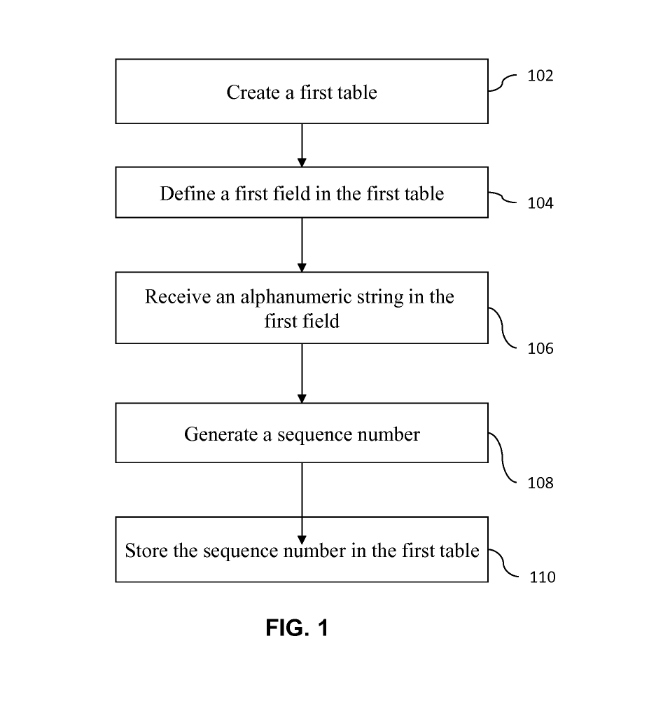

Referring now to FIG. 1, an embodiment of a computer implemented method for generating an account number is depicted. As in a block 102, the method includes a step of creating a first table. In this instance, the first table, associated with the number generation setup, is also the master table. As in a block 104, a first field is defined in the first table. The field so defined is capable of recording an alphanumeric input. In a further block, 106, an alphanumeric string is received into the first field. This alphanumeric string is generally in the format of the account number that is desired. Thus, the string may comprise a set of differing elements, such as, in the case of a bank account number, alphanumeric characters defining the type of account, characters defining a branch code for a particular branch of the bank, a currency code denoting the currency used in the account, a service outlet identification number where the service outlet could be a branch or sub-branch, a service outlet alias, a short code for a data center, a customer information file identification code, a product code, and, further, a set of user defined set of characters. Each or any of these discrete fields that, as a whole, comprise the alphanumeric string, can in themselves take a desired alphanumeric value. In a further block, 108, a sequence number is generated, and, as in a block 110, the sequence number is stored in the first table. The sequence number is a running sequence number associated with the alphanumeric account string input, and may be maintained accordingly. That is, each account number string is associated with a specific sequence number, unique to that instance.

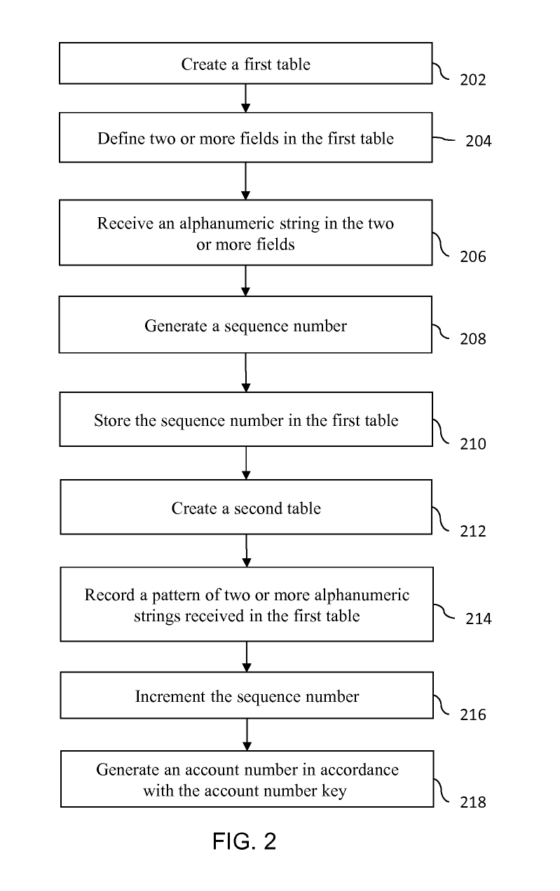

Referring now to FIG. 2, in a preferred embodiment, a first table is created, as in a block 202, two or more fields are defined in the first table, as in a block 204. These fields may receive an alphanumeric string, as previously established. An alphanumeric string is then received in the two or more fields, as in a block 206. The purpose of the two or more fields defined is in instances where multiple account number strings are desired to be input. A sequence number is then generated, as in a block 208, and stored, as in a block 210.

Following the generation of the sequence number, a second table is created, as in a block 212. Where the first table is the master table, so the second table may be a child table, and these two are distinct. Further, as in a block 214, a pattern of two or more alphanumeric strings received in the first table are recorded. The pattern so recorded is then used to create an account number key.

As previously described, the account number is, in essence, an alphanumeric string that consists of a variety of discrete alphanumeric sets. However, as these sets that comprise the string follow certain convention, such as the inclusion of characters designating a ‘type of account’ and so on, they may be codified accordingly. In the present embodiment, then, when these codes are being input, the type for which the code is being defined may be recorded and stored in the first, or master, table. When a plurality of codes is recorded, the first table is thereby in possession of an account number key.

Further, as in a block 216, the sequence number associated with the alphanumeric string that has been input is incremented accordingly, and the account number is then generated in accordance with the recorded account number key.

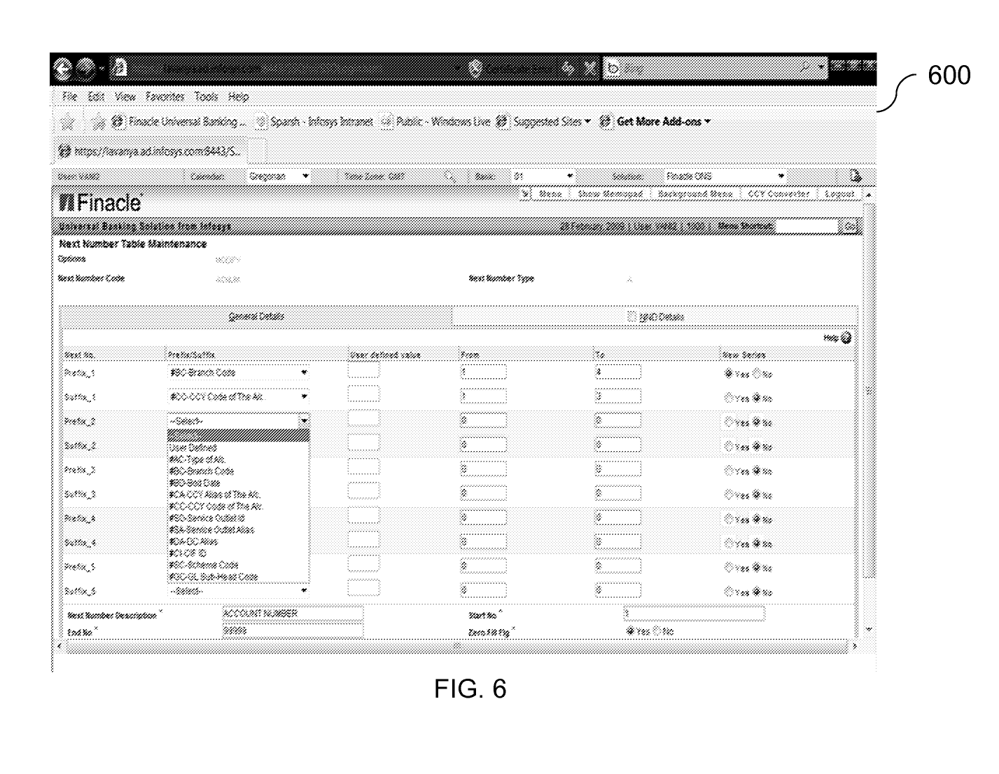

In a descriptive example that is not intended to limit the invention, if a bank account number is required to be generated, a bank may want the account number to consist of, for example, a branch code designating the branch where the account has been opened, a type of account code, a code referring to the year when the account was opened, and the sequence number. In this instance, each such code is defined and identified, by means of, for example, a menu option. An example of such is depicted in FIG. 6, where the system 600 shows a next number table definition screen, where elements that can be used as a component of an account number are listed in the drop down displayed.

When so defined, these details are stored in the master table. Then, based on values passed at number generation time, or runtime, the account number key is formed and this is then stored in the child table. In this way, the account number may be generated in accordance with a format desired, and is generally configurable in the way the combination of such codes is used.

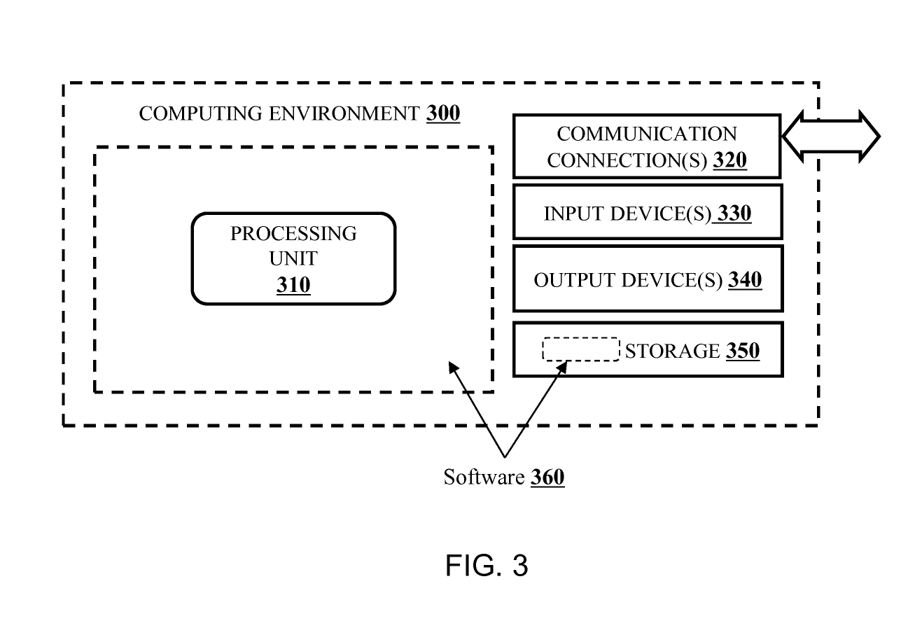

Referring now to FIG. 3, a computing environment 300 comprising a processing unit 310, a communication connection 320, an input device 330, an output device 340, and a processor readable storage medium 350, in operable communication with the processing unit 310, is depicted. The computing environment runs a software 360, the software 360 suitable for the generation of an account number, and consisting of one or more programming instructions stored in the processor readable storage medium.

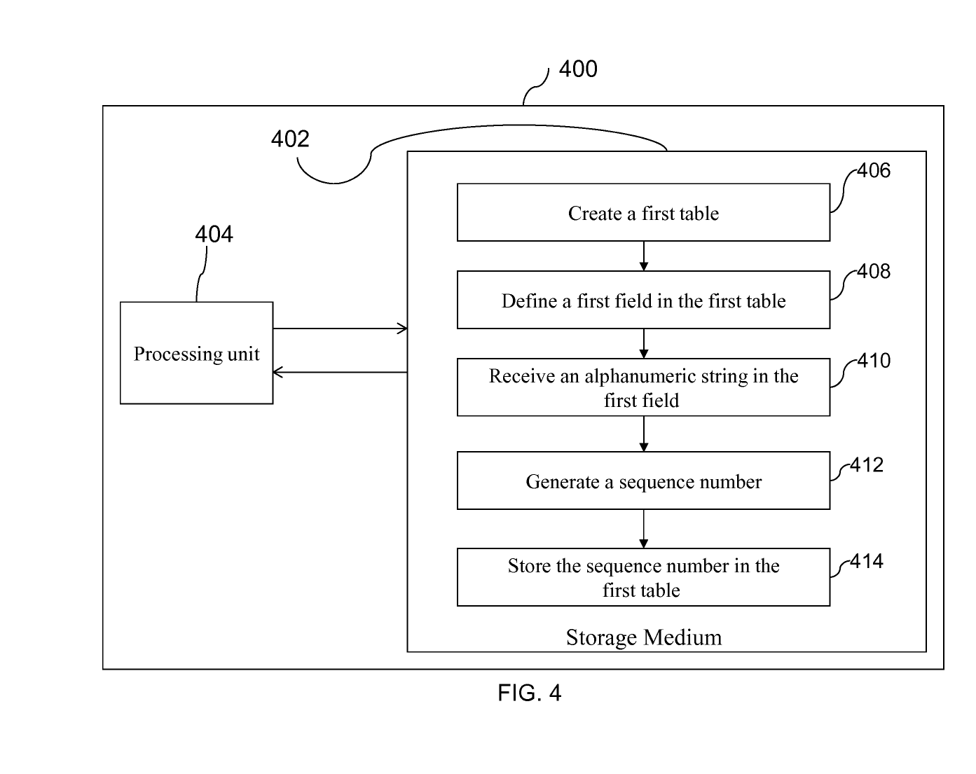

Referring now to FIG. 4, an aspect of a system for the generation of an account number is illustrated. In FIG. 4, a subset of the computing environment shown in FIG. 3 is depicted, and designated 400. Computing environment 400 comprises a processing unit 404 in operable communication with a processor readable storage medium 402. The processor readable storage medium 402 contains one or more programming instructions, including, as depicted, the creation of a first table 406 in the processor readable storage medium, the definition of a first field in the first table, as in a block 408, the first field capable of receiving at least one alphanumeric character. An alphanumeric string is then received and recorded in the first field, as in a block 410 and by means of, for example, the input device 330 as in FIG. 3. Additionally, as in a block 412, a sequence number is generated and, as in a block 414, stored in the first table.

In a further aspect of the system described, an account number may be generated by means of an account number key, the account number key stored in a second table, in accordance with the embodiment described by means of FIG. 2, above.

In further aspects of the system and method described, a maximum limit of ten alphanumeric fields may be imposed. In a further aspect, a maximum size and a minimum size is set for each of the at least one alphanumeric fields. Setting limits in this fashion helps in reducing the size of the account number to what is applicable, or necessary, for a given banking application. Where a maximum size and a minimum size may be defined, it is not necessary that unused space within these bounds be abandoned. To that end, an additional aspect includes the use of a zero fill, where the unused space in each of the alphanumeric fields is filled with one or more representations of the numeral ‘0’.

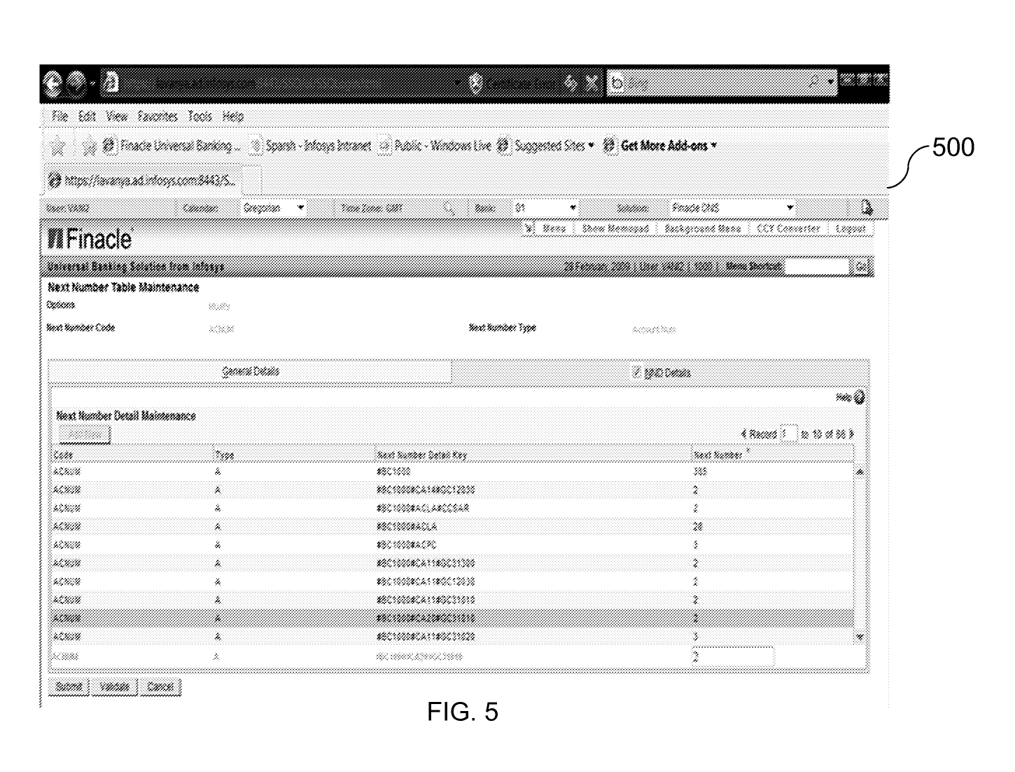

Additional aspects include the association of a sequence number with an alphanumeric string, where the alphanumeric string is adjacent to the sequence number. When the string defined is modified, the sequence number resets to zero. Two or more sequence numbers may be associated with a corresponding string in this way. Such functionality enables, for example, the bank, to pick discrete component sets, or codes, from the discrete alphanumeric string, and identify, or create, account numbers thereby. Since each sequence number is associated with an adjacent field, new numbers may be distinguished solely on the basis of any of the discrete alphanumeric fields, by reading the status of the sequence number. By doing so, flexibility is obtained in the definition and assignment of account numbers. An example implementation of this mechanism, that depicts how the system 500 maintains account numbers internally, and provides a next number when required, is shown in FIG. 5.

In an additional aspect, check digit functionality is incorporated into the account number. This is done by means of reserving an alphanumeric field within the string. While an implementation of check digit functionality is not, necessarily, directly incorporated into an embodiment of the system or method described, an account number generated thereby does provide support for the use of check digit verification. Particularly, by defining a specific alphanumeric field, the content of said field may be leveraged to implement an effective check digit methodology. For example, but without limitation to the claims, in an embodiment of the present implementation, if, say, the letter ‘F’ is inserted into the check digit field, check digit verification may be performed on the entire alphanumeric string that comprises the account number. In a similar vein, if, for example, the letter ‘N’ is inserted into the check digit field, a check digit verification step may be declined. Additionally, if a letter ‘S’ is inserted, custom logic that includes check digit verification on all or some of the numeric parts, and the numeric parts only, of the account number may be performed. The characters used for such functionality are not limited to those described, and may be defined by a user instead.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The preceding description is presented to enable a person of ordinary skill in the art to make and use the invention and is provided in the context of the requirement for a obtaining a patent. This description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer implemented method for generating an account number, the method comprising:
creating a first table;
defining a first field in the first table, wherein the first field is adapted to receive at least one alphanumeric character;
receiving an alphanumeric string in the first field, wherein the alphanumeric string comprises one or more alphanumeric characters;
generating a sequence number; and
storing the sequence number in the first table.

2. The method as claimed in claim 1, wherein there are two or more fields defined in the first table, each of the two or more fields adapted to receive an alphanumeric string.

3. The method as claimed in claim 2, wherein the method further comprises:
creating a second table;
recording a pattern of two or more alphanumeric strings received in the first table and creating an account number key thereby, the account number key stored in the second table;
incrementing the sequence number; and
generating an account number in accordance with the account number key received.

4. The method as claimed in claim 3, wherein there are at most ten alphanumeric fields.

5. The method as claimed in claim 3, wherein the account number comprises the two or more alphanumeric strings and the sequence number, the sequence number adjacent to an alphanumeric field.

6. The method as claimed in claim 5, wherein the sequence number is associated with an alphanumeric string in an adjacent alphanumeric field, the sequence number resetting to zero on a modification thereof.

7. The method as claimed in claim 6, wherein the method further comprises two or more sequence numbers, each of the two or more sequence numbers associated with a corresponding alphanumeric string.

8. The method as claimed in claim 3, wherein the method further comprises setting a maximum size and a minimum size for each of the at least one alphanumeric fields.

9. The method as claimed in claim 8, wherein the method further comprises filling an empty space in each of the two or more alphanumeric fields with one or more zeroes.

10. The method as claimed in claim 3, wherein the account number key includes an alphanumeric branch code field.

11. The method as claimed in claim 3, wherein the method further comprises creating a check digit field.

12. The method as claimed in claim 11, wherein the method further comprises performing a check digit calculation on the entire range of alpha-numeric fields.

13. The method as claimed in claim 11, wherein the method further comprises performing a check digit calculation on a subset of the alpha-numeric fields.

14. The method as claimed in claim 11, wherein the method further comprises performing a check digit calculation on a subset of numerals contained in the alpha-numeric fields.

15. The method as claimed in claim 11, wherein the method further comprises performing a check digit calculation on all numerals contained in the alpha-numeric fields.

16. A system for generating an account number automatically, the system comprising:
a processor readable storage medium in communication with a processor, wherein the processor readable storage medium contains one or more programming instructions for:
creating a first table, the first table stored in the processor readable storage medium;
defining a first field in the first table, wherein the first field is adapted to receive at least one alphanumeric character;
receiving an alphanumeric string in the first field, wherein the alphanumeric string comprises one or more alphanumeric characters;
generating a sequence number; and
storing the sequence number in the first table.

17. The system as claimed in claim 16, wherein there are two or more fields defined in the first table, each of the two or more fields adapted to receive an alphanumeric string.

18. The system as claimed in claim 17, wherein the system further comprises:
creating a second table, the second table stored in the processor readable storage medium;
recording a pattern of two or more alphanumeric strings received in the first table and creating an account number key thereby, the account number key stored in the second table;
incrementing the sequence number; and
generating an account number in accordance with the account number key.

19. The system as claimed in claim 18, wherein the system further comprises setting a maximum size and a minimum size for each of the at least one alphanumeric fields.

20. The system as claimed in claim 19, wherein the system further comprises filling an empty space in each of the two or more alphanumeric fields with one or more zeroes.

21. The system as claimed in claim 18, wherein the account number key comprises two or more alphanumeric strings and the sequence number, the sequence number adjacent to an alphanumeric field.

22. The system as claimed in claim 21, wherein the sequence number is associated with an alphanumeric string in an adjacent alphanumeric field and the sequence number resets to zero on a modification thereof.

23. The system as claimed in claim 22, wherein the system further comprises two or more sequence numbers, each of the two or more sequence numbers associated with an alphanumeric string.
